(19) United States
(12) Patent Application Publication
(10) Pub. No.: US 2002/0120511 A1
(43) Pub. Date: Aug. 29, 2002

(54) System and method for print-on-demand electronic awards for motivation programs

(75) Inventor: Mark D. Hanes, Fenton, MO (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Maritz Inc.

(21) Appl. No.: 10/059,810

(22) Filed: Jan. 29, 2002

Related U.S. Application Data
(60) Provisional application No. 60/264,945, filed on Jan. 30, 2001.

(51) Int. Cl. G06F 17/60

(52) U.S. Cl. 705/14

(57) ABSTRACT

A system and method for allowing a customer to motivate a participant. From a motivation website, the customer selects and customizes a motivation document and a motivation award to be printed and presented to the participant as an integrated motivation package. In one embodiment, the motivation document and motivation award are printed on a single sheet of paper for presentation to the participant. The customer selects the motivation document from a library of motivation documents or other communications templates. The customer selects the motivation award from a collection of motivation awards including multiple vendor services.

### CROSS REFERENCE TO RELATED APPLICATION

This application is based upon U.S. Provisional Patent Application No. 60/264,945, entitled SYSTEM AND METHOD FOR PRINT-ON-DEMAND ELECTRONIC AWARDS FOR MOTIVATION PROGRAMS, filed Jan. 30, 2001. The entirety of such patent application is incorporated by reference herein.

### BACKGROUND OF THE INVENTION

1. Field of the Invention

The present invention relates to the field of motivation programs. In particular, this invention relates to an on-line method and system for allowing a customer to motivate a participant by presenting to the participant one of a plurality of motivation packages customized by the customer.

2. Description of the Prior Art

Motivation programs (hereinafter, “programs”) provide companies (hereinafter, “customers”) with a method for attracting, retaining, awarding, and recognizing employees, members, volunteers, contractors, distribution-channel personnel, and other customers (hereinafter, “participants”). For more information regarding such programs, refer to: U.S. Pat. No. 5,956,695 entitled FILTER PROCESSOR AND METHOD FOR IMPLEMENTING A PROGRAM, U.S. patent application Ser. No. 10/000,680 entitled SYSTEM AND METHOD FOR PRINT-ON-DEMAND COMMUNICATIONS CAMPAIGNS FOR MOTIVATION PROGRAMS, filed Oct. 31, 2001, and U.S. patent application Ser. No. 09/840,648 entitled METHOD AND SYSTEM FOR ELECTRONICALLY SELECTING, MODIFYING, AND OPERATING A MOTIVATION AWARDS PROGRAM, filed Apr. 23, 2001, all assigned to Maritz Inc. and incorporated herein by reference.

There is a need for an on-line award system which provides customers with an integrated motivation package including a document and an award customizable by customers to be provided to participants as an integrated motivation package at various times throughout the program. There is also a need for a system which allows printing of customized documents and awards directly from a website to be presented to a participant. There is also a need for a system in which the customer purchases an award on-line and the participant redeems the award wherein the award is identified by an encrypted serial number.

For these reasons, a system for allowing a customer to motivate a participant by presenting the participant with an integrated motivation package is desired to address one or more of these and other needs.

### SUMMARY OF THE INVENTION

It is an object of this invention to provide an on-line method and system which provide customers with an integrated motivation package including a document and an award customizable by customers to be provided to participants as an integrated motivation package at various times throughout the program.

It is another object of this invention to provide a method and system which allow printing of customized documents and awards directly from a website to be presented to a participant.

It is an object of this invention to provide a method and system for allowing the customer to purchase an award on-line and allowing the participant to redeem the award wherein the award is identified by an encrypted serial number.

According to one aspect of the invention, the invention includes a system comprising an on-line motivation website, a first printing program, and a second printing program. The on-line motivation website implements a motivation program allowing a customer to motivate a participant by selecting a motivation package to be provided to the participant. The first printing program associated with the website creates an electronic version of the selected motivation package to be transmitted to the customer, the participant, or an agent of the customer or participant. The second printing program associated with the customer, the participant, or an agent of the customer or the participant renders the transmitted, electronic version of the selected motivation package to a printer for printing the motivation package so that the printed motivation package is capable of being presented off-line to the participant.

According to another aspect of the invention, the invention includes a method for allowing a customer to motivate participants. The method includes the steps of:

allowing the customer to select via a website accessible on-line a category of integrated motivation packages;

allowing the customer to select one of a plurality of motivation documents related to the selected category and to select one of a plurality of motivation awards related to the selected category, the selected document and the selected award to be presented to the participants as the integrated motivation package; and

allowing the customer to print the selected motivation package at a location designated by the customer or a location designated by the participant receiving the motivation package wherein the selected motivation document and/or award includes customized text relating to motivation of the participant and/or text indicating the name of the participant receiving the motivation package, wherein the web site includes a first application program for assembling a specification representing the selected motivation package, and wherein a second application program associated with the customer renders the specification to a printer or monitor of the customer or participant.

According to yet another aspect of the invention, the invention includes a system for allowing a customer to motivate a participant by presenting to the participant an integrated motivation package customized by the customer. The system includes a plurality of motivation documents in electronic format, a plurality of motivation awards in electronic format, a website accessible on-line by the customer, and software. The website allows the customer to select one of the motivation documents and to select at least one of the motivation awards to be presented to the participant as the integrated motivation package. The software is responsive to the customer's on-line selections for printing the selected motivation document and the selected motivation award at a location designated by the customer or a location designated by the participant. The selected motivation document includes text indicating the motivation and/or text indicating the participant's name, such text being optionally designated by the customer.

In one form, in a computer system having a graphical user interface including a display and a user interface selection device, the invention includes a method for allowing a customer to motivate a participant by presenting to the participant an integrated motivation package. The method includes:

displaying a list of motivation packages on the display;

receiving a first user signal representing a selection, by the user with the user interface selection device, of a specific motivation package from the list on the display;

in response to the first user signal, displaying the selected, specific motivation package on the display;

receiving a second user signal representing a selection, by the user with the user interface selection device, of a print function; and

in response to the second user signal, executing software to print the selected, specific motivation package using the print function.

In another form, the invention includes one or more computer-readable media having computer-executable components for allowing a customer to motivate a participant. The components include a generation component, an interface component, and a print component. The generation component creates the specifications associated with a selected motivation package. The interface component accepts the created specifications from the generation component and transmits the created specifications to a print location designated by the customer or participant. The print component renders the transmitted, created specifications at the print location for presentation to the participant.

Alternatively, the invention may comprise various other methods and apparatuses.

Other features will be in part apparent and in part pointed out hereinafter.

### BRIEF DESCRIPTION OF THE DRAWINGS

FIG. 1 is a block diagram of one embodiment of the invention illustrating the main aspects.

FIG. 2 is an exemplary flow chart of the invention in which the customer selects, purchases, and customizes a motivation package.

FIG. 3 is a block diagram showing the motivation package as part of a collection of awards available in a motivation program.

FIG. 4 is an exemplary flow chart of the invention in which the customer creates a motivation package by selecting a motivation award from an exemplary set of available awards.

FIG. 5 is a block diagram of the invention illustrating the relationship between components of the print software.

FIG. 6 is an exemplary flow chart illustrating customer interaction with the user interface of the invention to select, customize, and print a motivation package.

FIG. 7 is a block diagram of the invention illustrating an exemplary computer-readable medium on which components of the invention may be stored.

Corresponding reference characters indicate corresponding parts throughout the drawings.

### DETAILED DESCRIPTION OF THE INVENTION

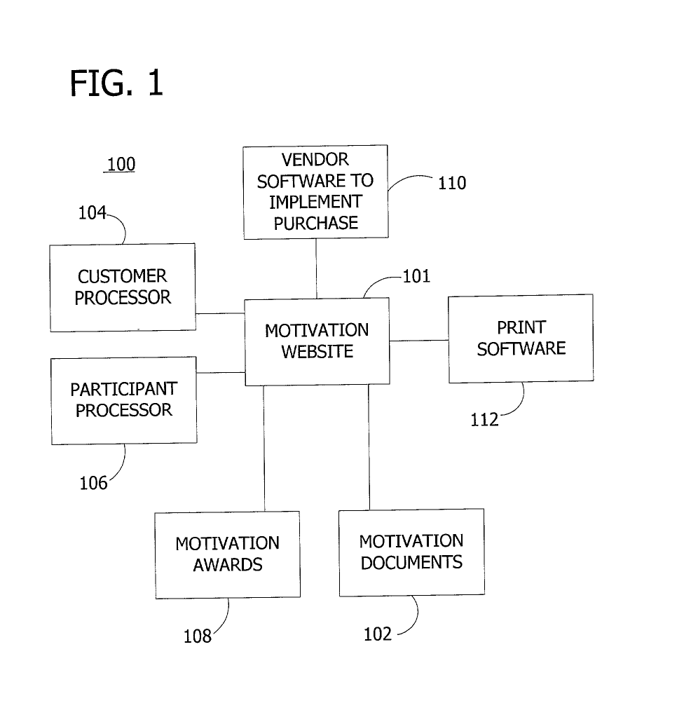

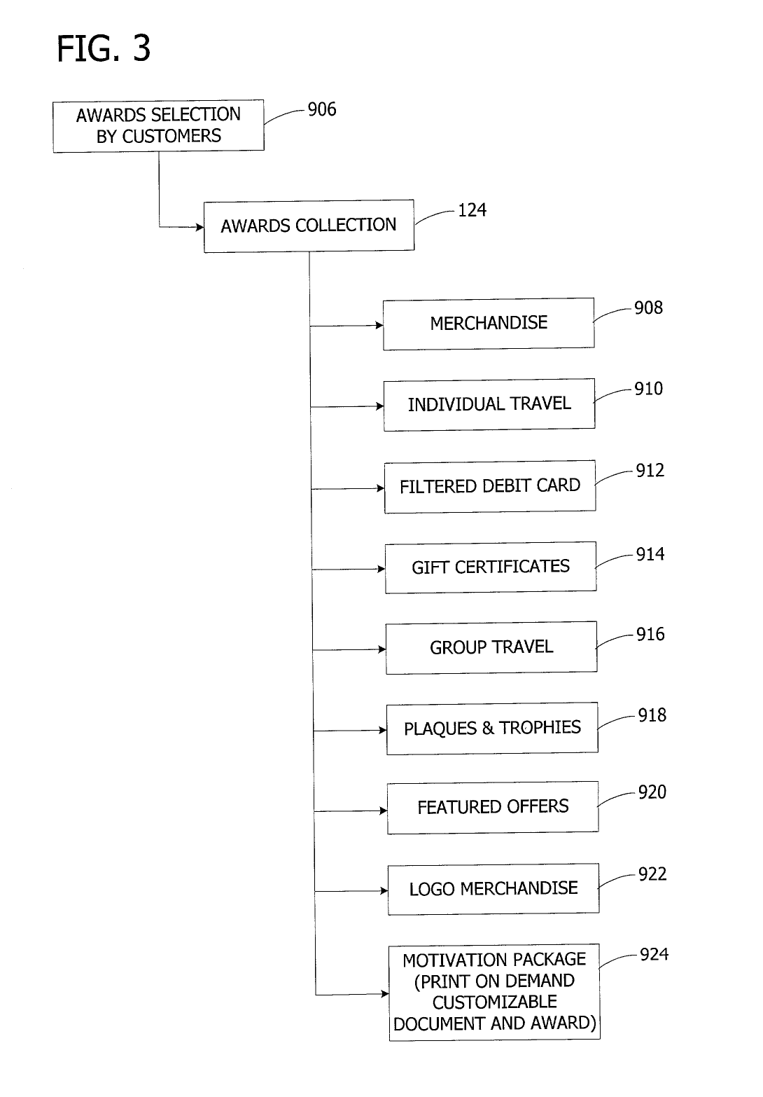

Referring to FIG. 1, a block diagram of one embodiment of the invention illustrates the main aspects of the invention. In general, the invention is a print-on-demand document and award system and method. The invention is an on-line method and system (hereinafter referred to as “system 100”) for allowing a customer to motivate a participant by presenting to the participant one of a plurality of motivation packages (see FIG. 3, reference character 924) customized by the customer. Each customer is generally a business or other entity having a plurality of participants such as employees, contractors, members, volunteers, distribution-channel people or other consumers. The customer is interested in providing a motivation package to these employees, its contractors and/or others such as its consumers as participants to recognize and award these participants for certain activities or performance. The desired performance includes, but is not limited to, achieving sales quotas, reaching a service anniversary date, or acquiring new skills. The motivation package or other electronic award includes motivation awards 108 combined with motivation documents 102 to which the customer can add personalized messages to recognize the participants. The customer or participant can print the motivation documents 102 and motivation awards 108 to a printing device selected by the customer immediately after purchase or later. In one embodiment, the customer prints and then immediately presents to the participant the motivation document 102 and the motivation award 108 as an integrated motivation package to provide immediate motivation. The system 100 is publicly accessible. The customer, as a member of the public or as a buyer of the program, accesses the system 100 to browse, select, purchase, and customize the motivation package. The participant, as a recipient of the motivation package, is assigned a login and/or password to view and possibly print the motivation package. The login/password is conveyed to the participant via electronic mail (“email”), postal mail, or otherwise. Motivation packages can be used in conjunction with award, incentive, recognition, or motivation programs or retention and retaining strategies or the like.

In one embodiment, the motivation document 102 and motivation award 108 are printed on a single sheet of paper for presentation to the participant. The single sheet of paper represents the motivation package, and may include a dashed or dotted line or perforations indicating separation between the motivation document 102 and the motivation award 108. After separation, the motivation document 102 is suitable for framing, and the motivation award 108 can be redeemed by the participant. In an alternative embodiment, the motivation document 102 and the motivation award 108 are printed on separate sheets of paper for presentation together to the participant as the motivation package.

Referring to FIG. 1, the system 100 includes a motivation website 101 or other gateway for allowing the customer to select and customize the motivation package via a customer processor 104. The motivation website 101 stores a plurality of motivation documents and motivation awards in electronic format in one or more computer-readable media, for example, accessible by a processor associated with the motivation website 101. The website 101 allows the customer to select on-line one of the motivation documents 102 to be presented to the participant and to select on-line one of the motivation awards 108 to be presented to the participant. From the motivation website 101, the customer can access a library of motivation documents 102 or other communications templates, a collection of motivation awards 108, print software 112, and vendor software 110. In one embodiment, the collection of motivation awards 108 includes multiple vendor services. The customer processor 104 can be part of any device which is capable of transmitting and receiving data, including, but not limited to, personal computers, laptop computers, handheld personal digital assistants, and cellular telephones. Those skilled in the art will note that the invention as described herein is operational in any computing system environment and not limited to any one type of computing platform, component, or model.

The library of motivation documents 102 are in digital format or another electronic format for access by computer processors. Motivation documents 102, or other documents or award and recognition documents, provide motivation for events relating to the performance, achievement, and hard work of the participants. The documents are suitable for framing. The motivation documents 102 include, but are not limited to, a certificate of achievement, an acknowledgment of service certificate, and a team accomplishment certificate. The customer optionally designates text indicating the name of the participant in the motivation document 102.

The collection of motivation awards 108 is in a digital format or another electronic format for access by computer processors. The motivation awards 108 include awards that the participant will find motivating as an award for past or ongoing achievements. In general, the award is a feature redeemable by voucher or a ticket or some other feature which can be authorized and/or delivered on-line. For example, the motivation awards 108 may include one or more coupons or gift certificates, redeemable at on-line and/or off-line retailers.

The print software 112 allows the customer to print the motivation package. The print software 112 includes software responsive to the customer's on-line selections for printing the selected motivation document and the selected motivation award at a location designated by the customer or a location designated by the participant. The selected motivation document includes text indicating the motivation and/or text indicating the participant's name. Such text is optionally designated by the customer. In one embodiment, the customer prints the motivation package on a printer local to the customer such as a standard color ink jet printer or laser printer. For example, the print software 112 may include a plug-in, downloadable via a processor, for an Internet browser. In this example, the plug-in would print the motivation package in a format such as a portable document format (PDF), a graphics interchange format (GIF), or a joint photographic experts group (JPEG). Those skilled in the art will note that there are variations by which software associated with the motivation website 101 and software associated with the customer or participant can effect a rendering of the motivation package for off-line presentation to the participant. Such variations are considered to be within the scope of the present invention.

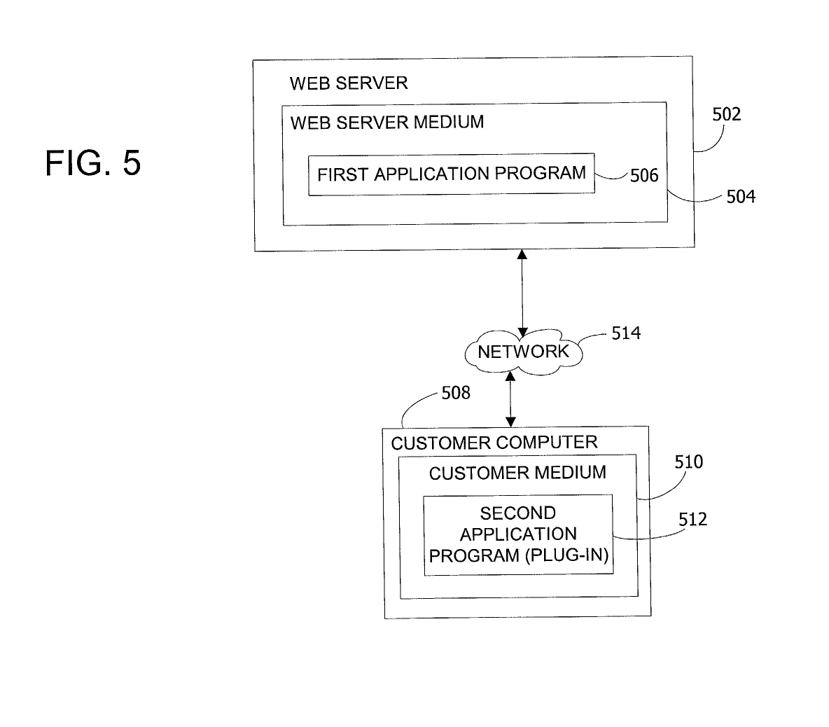

The print software functions in two parts. FIG. 5, described in detail below, illustrates the connection between these two parts. A first computer program or a first application program associated with a web server creates dynamic content. That is, the first computer program generates an electronic version of the motivation package or otherwise assembles a specification representing the motivation package for transmission to the customer for printing. A second computer program associated with a desktop computer or other computer of the customer responds to instructions generated by the first computer program to print the transmitted, electronic version of the motivation package. That is, the second computer program renders the assembled specification to a monitor and/or printer of the customer or participant. In one embodiment, the second application program is a plug-in for an Internet browser. Those skilled in the art will note that the generated, electronic version of the motivation package can be transmitted to the customer via any network protocol or other means of electronically communicating between two computing devices. For example, the specification may be transmitted via a transmission control protocol/Internet protocol (TCP/IP) over a global computer network such as the Internet.

In one embodiment, the vendor software 110 is associated with the motivation website 101 offering the motivation packages. In another embodiment, a third party provides the vendor software 110. The vendor software 110 includes credit card software for allowing the customer to purchase the motivation package on-line. The credit card software includes standard e-commerce features such as on-line entry of credit card information, delivery address information, and billing address information. Additionally, the credit card software includes an on-line shopping cart for allowing the customer to designate items to be purchased collectively.

The vendor software 110 also includes software for generating a serial number to be associated with and displayed on each purchased motivation award 108. The serial number is used to uniquely identify the motivation award 108. The attributes associated with the serial number include, for example, the value, type, purchasing customer, and redemption status of the purchased motivation award 108. The system 100 includes a database for storing the serial numbers and associated attributes. The system 100 provides tracking and functionality to support the replacement of lost or stolen motivation awards 108. In the event of a specific customer or participant losing the motivation award 108, the database is consulted to verify the customer's purchase of the motivation award 108 and the participant's non-redemption of the motivation award 108. The serial number associated with the lost motivation award 108 will be marked invalid by identifying the serial number as such in the database. An identical motivation award 108 with a new serial number can then be issued to the customer or participant. The customer or participant can be notified of the re-issued motivation award and new serial number via email, postal mail, or otherwise.

In another embodiment, the vendor software 110 includes encryption software for delivering, storing, and verifying the serial numbers associated with the motivation awards 108. The encryption will allow safe, secure shopping by the customer and redemption by the participant over insecure mediums such as the Internet or wireless networks. For example, the encryption software may be associated with the motivation website 101 providing the motivation programs or with a third party vendor.

The collection of motivation awards 108 is derived from a database of merchants. The merchants are national, regional, and/or local to the participant and/or customer. In one embodiment, the merchants are on-line suppliers of luxury and pampering products and services. For example, some of the merchants provide luxury transportation services, serve as a broker/agent for access to professional entertainment, and provide on-line flowers and gift arrangements. Other merchants may provide spa and massage therapy sessions, restaurant and fine dining options, professional and individual cleaning services, and aerobic instruction for personal health and fitness.

The participants use the serial number printed on the motivation award 108 to redeem the award for a product or service. The redemption can occur on-line by inputting the serial number into the website of an on-line retailer to complete a purchase by the participant. The redemption can also occur off-line by presentation of the motivation award 108 by the participant to a brick-and-mortar store. The on-line retailer or store employees can verify the validity and non-redemption of the motivation award 108 by comparing the serial number against the database of serial numbers. This comparison can occur via an automated telephone system or electronically via a computer accessing the database. After the participant redeems the motivation award 108, the redemption status of the serial number associated with the award is marked invalid by identifying the serial number as such in the database. After a predetermined time, the serial number is returned to the pool of available serial numbers to be associated with newly purchased motivation awards 108.

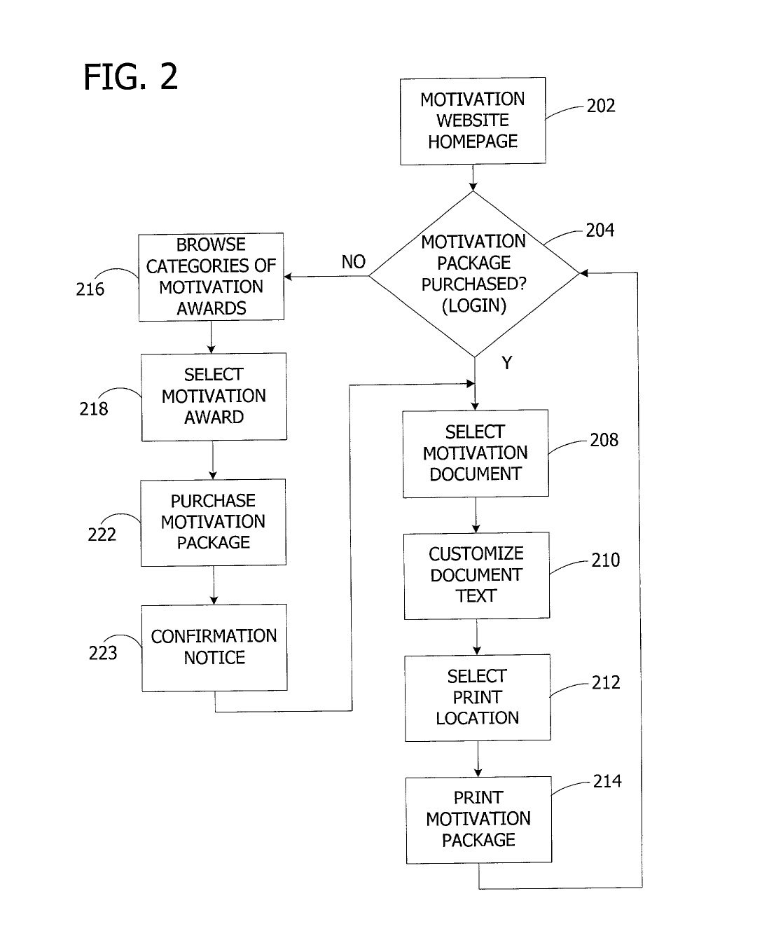

Referring next to FIG. 2, the customer begins the process of selecting and customizing the motivation package by accessing the homepage 202 of the motivation website 101. If the customer has not previously purchased at 204 a motivation package or wishes to purchase additional motivation packages, the customer is directed to browse at 216 the award options or categories from which the customer selects, customizes, and creates the motivation package. Typical categories include transportation, professional entertainment, dining, personal deliveries (flowers, candy, gift baskets, etc.), cleaning services, health & fitness, child care, personal telecommunications, spa & relaxation therapy, and travel. In general, the customer may first select a category and then select related a motivation award 108 and motivation document 102 within the category. The customer selects at 218 a specific motivation award 108 from the collection of available awards. The customer purchases at 222 the motivation package and receives at 223 a confirmation notice of the purchase on-line and/or through email notification. The confirmation notice provides access to format, personalize, and print the motivation document 102. To customize the text associated with the motivation document 102, the customer selects at 208 a document from a library of motivation documents 102. The motivation website 101 may include ideas for personalizing the text to be printed on the motivation documents 102. The customer can optionally customize at 210 the text to indicate the motivation/achievement and/or the participant's name. The customer positions text reflecting the motivation award 108 on the motivation document 102. The customer selects at 212 the print location for the motivation package, and authorizes printing at 214. In one embodiment, the customer interacts with the motivation website 101 through a primary, parent browser window associated with the motivation website 101. That is, the motivation website 101 does not produce daughter windows.

From the motivation website homepage 202, the customer can log in at 204 to select at 208 the motivation document 102 and proceed as above if the customer previously purchased at 222 a motivation package. This case applies when the customer has purchased one or more motivation packages, but has not yet printed all the related motivation documents 102 and motivation awards 108. In one embodiment, the customer can return to print the motivation documents 102 and motivation awards 108 for sometime after purchase of the motivation package.

The integrated motivation packages may be, for example, organized into categories to facilitate selection by the customer. The customer selects at least one of the motivation documents related to the selected category and selects at least one of the motivation awards related to the selected category to be presented to a participant as an integrated motivation package.

One or more computer-readable media store computer-executable instructions for performing the method illustrated in FIG. 2.

Referring next to FIG. 3, a block diagram illustrates the motivation package as part of a collection of awards available in a motivation program. In a motivation program, the customer selects at 906 the awards to be available by accessing at 124 an awards collection. The awards collection includes, but is not limited to, merchandise 908, individual travel 910, a filtered debit card 912, gift certificates 914, group travel 916, plaques and trophies 918, featured offers 920, logo merchandise 922, and a motivation package 924. The motivation package 924 combines the motivation document 102 with one of the other awards available in the awards collection 124.

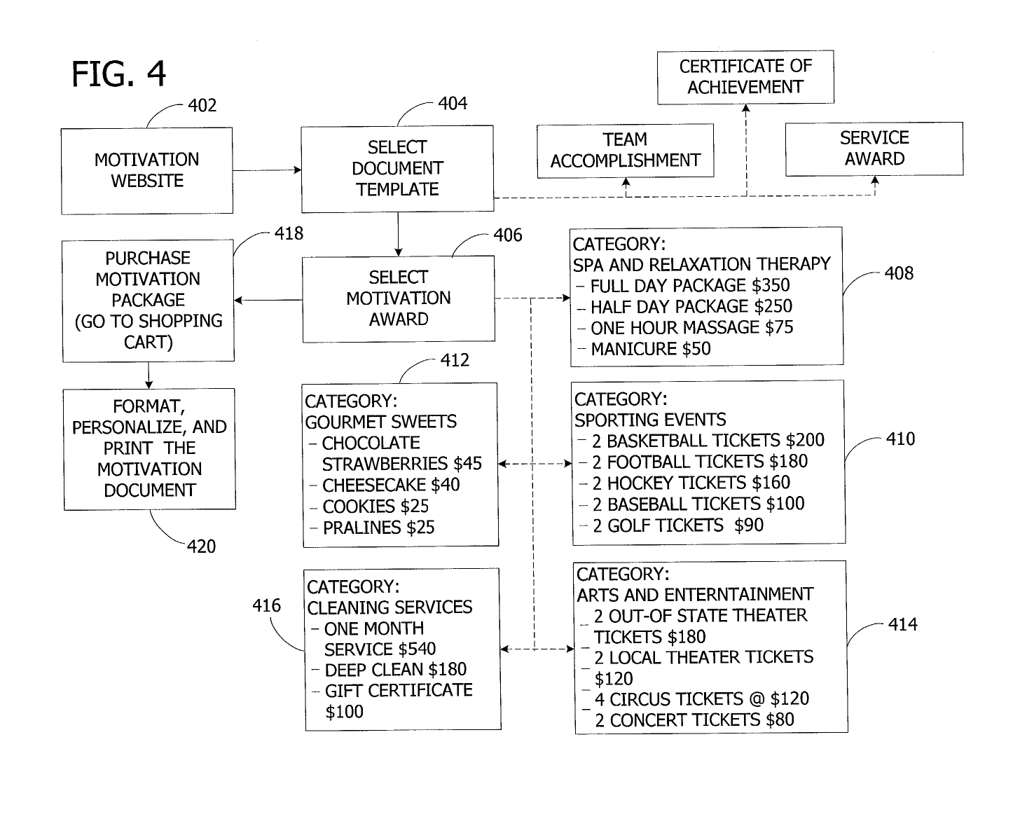

Referring next to FIG. 4, the customer selects and customizes the motivation package by accessing at 402 the motivation website 101 in an alternate embodiment. After reviewing instructions on the operation of the motivation website 101, the customer selects at 404 a document template from the available document templates. The customer personalizes and customizes the document templates by adding information such as representative logos, icons, descriptors, etc. After selecting the document template, the customer selects at 406 the motivation awards 108. The customer selects one or several of the available motivation awards 108. The categories of the available motivation awards 108 include, but are not limited to, spa and relaxation therapy 408, sporting events 410, gourmet sweets 412, cleaning services 416 and arts and entertainment 414. The categories are further defined to include such options as a full day spa package, basketball tickets, gourmet dessert platters, monthly home cleaning services and theater tickets. In general, the award is a feature redeemable by voucher or a ticket or some other feature which can be authorized and/or delivered on-line. After selecting the motivation award 108, the customer purchases at 418 the motivation package by paying a fee for the motivation award 108 and/or motivation document 102 using the shopping cart. After purchase confirmation, the customer formats, personalizes and prints at 420 the motivation document 102 for presentation to the participant.

Those skilled in the art will note that there are many ways that the customers can customize the text associated with the motivation documents 102, all of such ways being within the scope of the present invention. For example, a document may indicate “Certificate of Achievement” and the customer can personalize the text by adding the name of the participant below the graphic header.

In one embodiment as described above, the customer selects on-line the motivation package including the motivation document 102 and the motivation award 108. There are at least three scenarios with respect to how the selected document and award come into the possession of the customer and/or the participant: (1) the selected document and selected award are provided to the customer for presentation to the participant; (2) the selected document is provided to the customer for presentation to the participant and the selected award is provided to the participant; or (3) the selected document and selected award are provided to the participant. Each scenario includes electronic transmission of the selected document and award to the customer or the participant or both for printing. The selected electronic form for transmission may include, but is not limited to, a document downloaded from a network such as the Internet, an email attachment, or a physical media such as a CD-ROM or floppy disk including the electronic transmission.

In cases where the document and/or award are provided to the customer, the customer then presents such to the participant. Those skilled in the art will recognize other delivery scenarios.

The following is an example of the first scenario noted above where the customer receives both the document and award for personal presentation to the participant. Initially, the customer selects on-line the motivation package including the motivation document 102 and the motivation award 108. The selected motivation document 102 and award 108 are subsequently delivered in electronic form to the customer on-line or as an email attachment for printing at the time of selection by the customer or for printing at some later time by the customer prior to the off-line delivery (personal presentation) of the document by the customer to the participant. After the customer has in her/his physical possession the selected and printed motivation document 102 and award 108, the customer can disseminate the integrated package by personally presenting both simultaneously (or separately) to the participant.

Referring next to FIG. 5, a block diagram illustrates the relationship between components of the print software. A web server 502 is associated with a provider of the system 100. The web server 502 includes a web server medium 504 storing a first application program 506 or a first printing program. The first application program 506 associated with the web server 502 creates an electronic version of the selected motivation package. The created, electronic version of the selected motivation program is transmitted to a customer computer 508 over a network 514. The customer computer 508 includes a customer medium 510 storing a second application program 512 or a second printing program. The second application program 512, associated with the customer (as in exemplary FIG. 5), participant, or an agent of the customer or participant, renders the transmitted, electronic version of the selected motivation package to a printer for off-line presentation to the participant. For example, the second application program 512 may be a plug-in associated with a web browser of the customer, participant, or an agent of the customer or participant that renders the transmitted, electronic version of the selected motivation package to a printer. That is, the customer may receive the electronic version of the motivation package and print such package to a printer local to the customer. Similarly, a participant may receive the electronic version of the motivation package and print such package to a printer local to the participant.

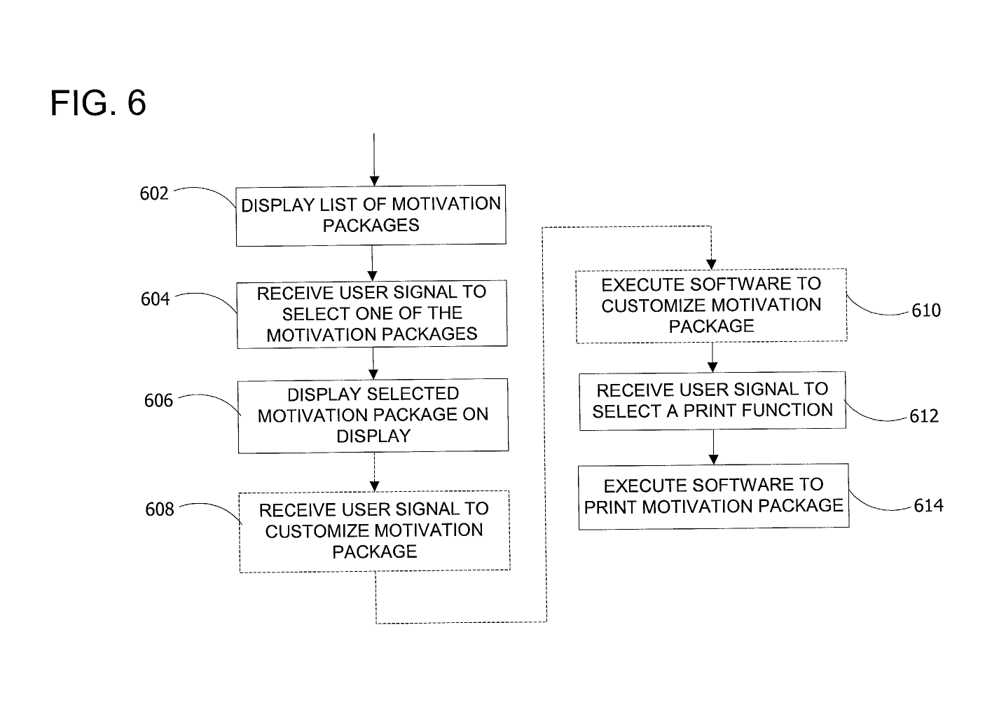

Referring next to FIG. 6, an exemplary flow chart illustrates customer interaction with the user interface of the invention to select, customize, and print a motivation package. A computer system has a graphical user interface including a display and a user interface selection device such as a keyboard or a pointing device. For example, the method illustrated in FIG. 6 may be performed by the customer by interacting with the system 100 via an Internet browser. A list of motivation packages is shown at 602 on the display. The system 100 receives at 604 a first user signal representing a selection, by the user with the user interface selection device, of a specific motivation package from the list on the display. In response to the first user signal, the system 100 displays at 606 the selected, specific motivation package to the customer. The system 100 receives at 612 a second user signal representing a selection, by the user with the user interface selection device, of a print function. In response to the second user signal, the system 100 executes software at 614 to print the selected, specific motivation package using the print function.

In one embodiment, prior to executing software to print, the system 100 receives at 608 a third user signal representing a selection, by the user with the user interface selection device, of a customizing function to customize the selected, specific motivation package. In response to the third user signal, the system 100 executes at 610 software to customize the selected, specific motivation package on the display using the customizing function.

One or more computer-readable media store computer-executable instructions for performing the method illustrated in FIG. 6.

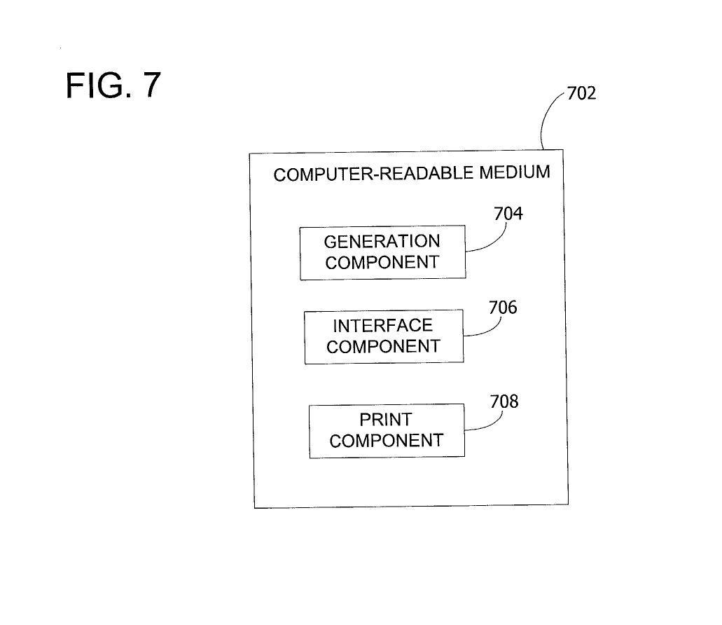

Referring next to FIG. 7, a block diagram illustrates an exemplary computer-readable medium on which components of the invention may be stored. One or more computer-readable media 702 has computer-executable components for allowing a customer to motivate a participant. A generation component 704 (e.g., first application program 506) creates the specifications associated with a selected motivation package. An interface component 706 (e.g., a driver for a network interface associated with the motivation website 101) accepts the created specifications from the generation component 704 and transmits the created specifications to a print location designated by the customer or participant. A print component 708 (e.g., second application program 512) renders the transmitted, created specifications at the print location for presentation to the participant. For example, the print component 708 renders the transmitted, created specifications to a printing device at the print location.

It is contemplated that the invention may be implemented in software and stored on a computer-readable media as described in FIG. 7. Further, those skilled in the art will note that a computer-readable medium may comprise physical hardware or one or more signals such as a carrier wave for storing data. In addition, although the invention has been described as being available over the Internet, it is contemplated that it may be implemented on the customer's local network.

In another embodiment, the system 100 allows the customer to purchase a plurality of motivation packages and print the motivation documents 102 and motivation awards 108 later as needed. In one embodiment, the customer has the ability to customize and print motivation documents 102 and motivation awards 108 for some time after purchasing the motivation package. The invention includes a preset time period associated with each selected motivation package during which customers work with the selected motivation package including, but not limited to, formatting, customizing (personalizing), and/or printing the motivation package. In some embodiments, for example, the time period may range from two hours to two weeks. The time period affords the customer flexibility in working with the motivation website 101 offering the motivation package in the event of network failure, customer time constraints, updates of award offerings, etc. In addition, the time period affords the participant a period of time during which the participant can print the received motivation package. After the time period expires for a particular selected motivation package, access to the selected motivation package by the customer is suspended. For example, the customer is unable to further modify, view, or print the selected motivation package after the time period elapses. Further, any saved modifications by the customer to the motivation package are deleted. In the embodiment where the participant has received the selected motivation package, the participant can no longer access the motivation package for printing after the time period expires.

In one embodiment of the invention, the motivation document 102 and motivation award 108 are purchased as an integrated motivation package to be delivered to the participant. In this embodiment, the motivation document 102 cannot be purchased without initially purchasing the motivation award 108. While delivery of the total motivation package is recommended, the customer can deliver either the motivation document 102 or the motivation award 108 to the participant separately. In an alternative embodiment, the motivation award 108 and motivation document 102 can be purchased separately and delivered together or separately. In another alternate embodiment, the customer presents the motivation document 102 and/or a “disabled” motivation award 108 to the participant as an incentive to motivate the participant to achieve a goal. When the participant achieves the goal, the motivation award 108 is “enabled.” The enabling and disabling occur by identifying the serial number of the motivation award 108 as either enabled or disabled in the database.

The following are examples of some of the several optional configurations and alternative embodiments of the invention. The customer selects an evening rental from a limousine rental company as the motivation award 108 to add to the motivation document 102 to create the motivation package. The customer selects opera tickets from an on-line ticket agent for two and a dinner for two from an on-line grocer as the motivation award 108 to add to the motivation document 102 to create the motivation package. The participant would use the on-line grocer award to select food to be delivered to the participant the day the opera tickets are used. The motivation website 101 can also access a participant processor 106 to optionally deliver the motivation package to the participant on-line. The participant processor 106 can be part of any device which is capable of transmitting and receiving data, including, but not limited to, personal computers, laptop computers, handheld personal digital assistants, and cellular telephones. The motivation package can be delivered to the participant as directed by the customer through the motivation website 101. The customer prints the motivation package at a retail document-printing company. The customer prints or authorizes the printing of the motivation package at a printer local to the participant. The participant is informed of the motivation package (such as by email) and prints at a location designated by the participant. The motivation package also includes paper stock which can be purchased by and delivered to the customer. The paper stock allows the customer to print the motivation document and award on high-quality paper to enhance the presentation of the motivation package. The customer is charged a fee for either or both the motivation document 102 and the motivation award 108.

In another embodiment, a customer history database maintains a log of the transactions performed by the customer. These transactions include the type of motivation package purchased, the specific motivation awards 108 purchased within each purchased motivation package, the specific motivation documents 102 printed from the motivation website 101, and the dates of all transactions. The customer history database allows the customers to select motivation packages which are meaningful to the participants. The customer accesses the customer history database to ensure that each participant receives an appropriate motivation package. For example, the customer may want to provide the same motivation package to a particular participant each service anniversary. In another example, the customer may want to provide a unique motivation package to recognize extraordinary achievement, or a motivation package to complement previously presented motivation packages. A reminder service is also available to remind customers of customer-input dates relating to the motivation packages so that the customer does not miss important motivation dates for its participants. The system 100 sends a reminder notice to the customer at the appropriate time electronically (e.g., via electronic mail) or non-electronically (e.g., via paper-based reminders sent via postal mail).

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above products and methods without departing from the scope of the invention, it is intended that all matter contained in the above description and shown in the accompanying drawings shall be interpreted as illustrative and not in a limiting sense.

What is claimed is:

1. A system comprising:
an on-line motivation website for implementing a motivation program allowing a customer to motivate a participant by selecting a motivation package to be provided to the participant;
a first printing program associated with the website for creating an electronic version of the selected motivation package to be transmitted to the customer, the participant, or an agent of the customer or participant; and
a second printing program associated with the customer, the participant, or an agent of the customer or the participant for rendering the transmitted, electronic version of the selected motivation package to a printer for printing the motivation package so that the printed motivation package is capable of being presented off-line to the participant.

2. The system of claim 1 wherein the website permits the electronic version of the selected motivation package to be customized on-line by the customer so that the printed motivation package is customized.

3. The system of claim 1 wherein the motivation package refers to the selected award and further comprising a customer history database accessible by the customer and maintaining a log of the transactions performed by the customer.

4. The system of claim 1 wherein the motivation package comprises a motivation document and a motivation award.

5. The system of claim 4 wherein the motivation document is selected from a group comprising of a certificate of achievement, an acknowledgment of service certificate, and a team accomplishment certificate.

6. The system of claim 4 wherein the motivation award is a gift certificate or a coupon.

7. The system of claim 1 wherein the second printing program is a plug-in associated with a web browser of the customer, the participant, or an agent of the customer or the participant.

8. The system of claim 1 wherein the first printing program and the second printing program communicate via a network.

9. A method for allowing a customer to motivate participants, said method comprising the steps of:
allowing the customer to select via a website accessible on-line a category of integrated motivation packages;
allowing the customer to select one of a plurality of motivation documents related to the selected category and to select one of a plurality of motivation awards related to the selected category, the selected document and the selected award to be presented to the participants as the integrated motivation package; and
allowing the customer to print the selected motivation package at a location designated by the customer or a location designated by the participant receiving the motivation package wherein the selected motivation document and/or award includes customized text relating to motivation of the participant and/or text indicating the name of the participant receiving the motivation package, wherein the web site includes a first application program for assembling a specification representing the selected motivation package, and wherein a second application program associated with the customer renders the specification to a printer or monitor of the customer or participant.

10. The method of claim 9 wherein allowing the customer to print the selected motivation package occurs prior to expiration of a predefined time period.

11. One or more computer-readable media for performing the method recited in claim 9.

12. A system for allowing a customer to motivate a participant by presenting to the participant an integrated motivation package customized by the customer, said system comprising:
a plurality of motivation documents in electronic format;
a plurality of motivation awards in electronic format;
a website accessible on-line by the customer for allowing the customer to select one of the motivation documents and to select at least one of the motivation awards to be presented to the participant as the integrated motivation package; and
software responsive to the customer's on-line selections for printing the selected motivation document and the selected motivation award at a location designated by the customer or a location designated by the participant wherein the selected motivation document includes text indicating the motivation and/or text indicating the participant's name, such text being optionally designated by the customer.

13. The system of claim 12 wherein the software comprises:
a first application program, associated with the website, for generating an electronic version of the motivation package, said electronic version to be transmitted to the customer for printing; and
a second application program, associated with the customer, the participant, or an agent of the customer or participant, for printing the transmitted, electronic version.

14. The system of claim 13 wherein the first printing program and the second printing program communicate via a network.

15. The system of claim 13 wherein the second application program is a plug-in for an Internet browser.

16. In a computer system having a graphical user interface including a display and a user interface selection device, a method for allowing a customer to motivate a participant by presenting to the participant an integrated motivation package, said method comprising the steps of:
displaying a list of motivation packages on the display;
receiving a first user signal representing a selection, by the user with the user interface selection device, of a specific motivation package from the list on the display;
in response to the first user signal, displaying the selected, specific motivation package on the display;
receiving a second user signal representing a selection, by the user with the user interface selection device, of a print function; and
in response to the second user signal, executing software to print the selected, specific motivation package using the print function.

17. The method of claim 16 wherein prior to executing software to print, further comprising:
receiving a third user signal representing a selection, by the user with the user interface selection device, of a customizing function to customize the selected, specific motivation package; and
in response to the third user signal, executing software to customize the selected, specific motivation package on the display using the customizing function.

18. One or more computer-readable media for performing the method recited in claim 16.

19. One or more computer-readable media having computer-executable components for allowing a customer to motivate a participant, said components comprising:
a generation component for creating the specifications associated with a selected motivation package;
an interface component for accepting the created specifications from the generation component and transmitting the created specifications to a print location designated by the customer or participant; and
a print component for rendering the transmitted, created specifications at the print location for presentation to the participant.

20. The computer-readable medium of claim 19 wherein the print component renders the transmitted, created specifications to a printing device at the print location.
